(19) United States
(12) Patent Application Publication
(10) Pub. No.: US 2005/0042536 A1
(43) Pub. Date: Feb. 24, 2005

(54) Photosensitive resin composition comprising quinonediazide sulfate ester compound

(76) Inventors: Joon-Yeon Cho, Suwon-city (KR); Kyong-Il Kwon, Yongin-city (KR); Soo-Jung Park, Anyang-city (KR)

Correspondence Address: FISH & RICHARDSON PC, 225 FRANKLIN ST, BOSTON, MA, 02110, US

(21) Appl. No.: 10/493,455

(22) PCT Filed: Oct. 21, 2002
(86) PCT No.: PCT/KR02/01968

(30) Foreign Application Priority Data
Oct. 24, 2001 (KR) 2001/0065809

(51) Int. Cl. G03C 5/18

(52) U.S. Cl. 430/141

(57) ABSTRACT

The present invention relates to a positive photosensitive resin composition for use in an LCD manufacturing process, and more particularly, to a composition comprising an alkali-soluble resin and novel quinonediazide sulfonic ester compound that has excellent development properties, leaves little residue, and has good chemical resistance, etc, and is also easily patterned and has high transmissivity, and thus is suitable for forming inter-insulating layers in LCDs and in integrated circuit devices.

### BACKGROUND OF THE PRESENT INVENTION

(a) Field of the Present Invention

The present invention relates to a positive photosensitive resin composition for use in an LCD manufacturing process, and more particularly, to a composition comprising an alkali-soluble resin and a novel quinonediazide sulfonic ester compound which have excellent development properties, leave little residue, have good chemical resistance etc., and is also easily patterned and has high transmissivity, and thus is suitable for forming inter-insulating layers in LCDs and integrated circuit devices.

(b) Description of the Related Art

TFT-LCDs and integrated circuit devices use inter-insulating layers to insulate between wiring arranged among layers.

When forming these inter-insulating layers, a photosensitive material that has a small number of manufacturing steps and is a good planarizer is preferably used to obtain inter-insulating layers of a desired pattern form.

In addition, the structure of TFTs has been evolving in order to improve the display quality of TFT-LCDs. Nowadays, it is increasingly common to employ thicker inter-insulating layers so as to achieve better planarization.

However, increasing the thickness of the insulating layer of a photosensitive resin composition results in a decrease of transparency thereof.

### SUMMARY OF THE PRESENT INVENTION

The present invention is made in consideration of the problems of the prior art, and it is an object of the present invention to provide a photosensitive compound that is suitable as a positive photosensitive insulating layer resin.

It is another object of the present invention to provide a photosensitive resin composition comprising the above-mentioned photosensitive compound that has excellent patternability, photosensitivity, solubility, chemical resistance, and heat resistance when used for insulating layers.

It is the other object of the present invention to provide a photosensitive resin composition with excellent transmissivity even as thick layers, so as to be suitable for insulating layers in LCD.

In order to achieve these objects, the present invention provides a photosensitive resin composition comprising, (A) an alkali-soluble acrylic copolymer resin, which is the product of copolymerization of
i) unsaturated carboxylic acid, anhydrous unsaturated carboxylic acid, or their mixture;
ii) an unsaturated compound with epoxy group(s); and
iii) an unsaturated compound of olefin

and has a polystyrene-equivalent molecular weight (Mw) of 5000˜20,000; and

(B) a photosensitive quinonediazide sulfonic ester compound, a product of the following compound shown in chemical formula 1, as its photosensitive composition:

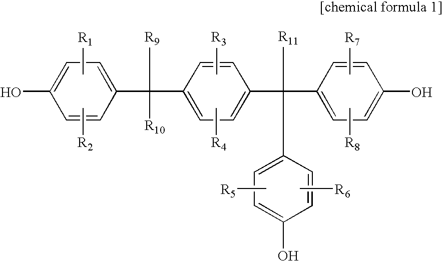

wherein R₁ to R₆ are independently or simultaneously hydrogen, a halogen, an alkyl with 1˜4 carbon atoms, an alkenyl with 1˜4 carbon atoms, or a hydroxyl; R₇ and R₈ are independently or simultaneously hydrogen, a halogen, or an alkyl with 1˜4 carbon atoms; and R₉ to R₁₁ are independently or simultaneously hydrogen or an alkyl with 1˜4 carbon atoms.

### DETAILED DESCRITPION OF THE PREFERRED EMBODIMENTS

This invention is described in detail in the following.

The present invention provides a photosensitive resin composition that includes an alkali-soluble resin and a novel photosensitive compound. The composition is used when forming insulating layers in LCD manufacture. It has superior photosensitivity, a low residue ratio, and high chemical resistance. In addition, it has good patternability and high transmissivity, so that it is suitable for forming insulating layers of LCDs and semiconductors.

Photosensitive Resin Composition

The individual components of the photosensitive resin composition of this invention are described in further detail in the following.

(A) Alkali-Soluble Resin

The alkali-soluble resin (A) in the photosensitive resin composition of this invention uses as its monomers: i) unsaturated carboxylic acid, anhydrous unsaturated carboxylic acid, or a mixture thereof; ii) an unsaturated compound with epoxy group(s); and iii) an unsaturated compound of olefin. These are radicalized in the presence of a solvent and a polymerization initiator. It is important to control the reaction so that the ratio of the unreacted monomer and the initiator is less than 5%, and so that the molecular weight of the final copolymer is between 5000 and 20,000.

The above steps are described in more detail in the following.

The ratio of the i) unsaturated carboxylic acid, anhydrous unsaturated carboxylic acid, or the mixture thereof that is used in the copolymerization of the present invention should be 5˜40 weight % of all the monomers, and more preferably, 10˜30 weight %. It is difficult to dissolve the monomer in an alkaline water solution when the monomer is less than 5 weight %, and on the other hand, the solubility in the alkaline water solution becomes excessive when it is more than 40 weight %.

Examples of the compound i) are: unsaturated mono-carboxylic acids such as acrylic acid and methacrylic acid; and unsaturated dicarboxylic acids such as maleic acid, fumaric acid, citraconic acid, mesaconic acid, itaconic acid, and anhydrides of these unsaturated dicarboxylic acids. These can be used alone or as a mixture. Among these, acrylic acid, methacrylic acid, and maleic anhydride are more desirable because they have high reactivity to form copolymers, and good solubility in an alkaline water solution.

In addition, the amount of the ii) unsaturated compound with epoxy group(s) used in the copolymerization in the present invention should be 10˜70 weight %, and more desirably, 20˜60 weight % of all the monomers. When the amount of the above-mentioned unsaturated compound with epoxy group(s) is below 10 weight %, the heat resistance of the resultant pattern becomes poor, and when it exceeds 70 weight %, the stability of the copolymer decreases.

Examples of the above-mentioned unsaturated compound with epoxy group(s) are: glycidyl acrylate, glycidyl methacrylate, α-ethyl glycidyl acrylate, α-n-propylglycidylacrylate, α-n-butylglycidylacrylate, acrylic acid-β-methylglycidyl, methacrylic acid-β-methylglycidyl, acrylic acid-β-ethylglycidyl, methacrylic acid-β-ethylglycidyl, acrylic acid-3,4-epoxybutyl, methacrylic acid-3,4-epoxybutyl, acrylic acid-6,7-epoxyheptyl, methacrylic acid-6,7-epoxyheptyl, α-ethyl acrylic acid-6,7-epoxyheptyl, o-vinylbenzyl glycidyl ether, m-vinylbenzyl glycidyl ether, and p-vinylbenzyl glycidyl ether. These can be used alone or as a mixture. Among these, glycidylmethacrylate, methacrylic acid-β-methylglycidyl, methacrylic acid-6,7-epoxyheptyl, o-vinylbenzyl glycidyl ether, m-vinylbenzyl glycidyl ether, and p-vinylbenzyl glycidyl ether are more desirable because of their high copolymerization reactivity and heat resistance of the formed pattern.

In addition, the amount of the iii) unsaturated compound of olefin used in the copolymerization in the present invention should be 10˜70 weight %, and more desirably, 20˜50 weight % of all the monomers. When the amount of the above-mentioned unsaturated compound of olefin is below 10 weight %, the stability of the acrylic copolymer decreases, and when it exceeds 70 weight %, the acrylic copolymer does not dissolve well in an alkaline water solution.

Examples of the above-mentioned unsaturated compound of olefin are: methylmethacrylate, ethylmethacrylate, n-butyl methacrylate, sec-butylmethacrylate, t-butyl methacrylate, methylacrylate, isopropyl acrylate, cyclohexyl methacrylate, 2-methylcyclohexylmethacrylate, dicyclopentanyloxyethylmethacrylate, isobornylmethacrylate, cyclohexylacrylate, 2-methylcyclohexylacrylate, dicyclopentanyloxyethylacrylate, isobornylacrylate, phenylmethacrylate, phenylacrylate, benzylacrylate, 2-hydroxyethylmethacrylate, styrene, α-methyl styrene, m-methyl styrene, p-methyl styrene, vinyltoluene, p-methyl styrene, 1,3-butadiene, isoprene, and 2,3-dimethyl 1,3-butadiene. These can be used alone or as a mixture. Among these, styrene, dicyclopentanyl methacrylate, and p-methyl styrene are more desirable because of their high copolymerization reactivity and solubility in an alkaline water solution.

Examples of solvent used in the above polymerization of alkali-soluble resin are methanol, tetrahydrofurane, ethyleneglycolmonomethylether, ethyleneglycol monoethylether, methylcellosolveacetate, ethylcellosolveacetate, diethyleneglycol monomethylether, diethyleneglycol monoethylether, ethyleneglycol dimethylether, ethyleneglycol diethylether, ethyleneglycol methylethylether, propyleneglycol monoethylether, propyleneglycol monoethylether, propyleneglycol propylether, propyleneglycol butylether, propyleneglycol methylethylacetate, propyleneglycol ethyletheracetate, propyleneglycol propyletheracetate, propyleneglycol butyletheracetate, propyleneglycol methylethylpropionate, propyleneglycol ethyletherpropionate, propyleneglycol propyletherpropionate, propyleneglycol butyletherpropionate, toluene, xylene, methylethylketone, cyclohexanon, 4-hydroxy 4-methyl 2-pentanon, methylacetate, ethylacetate, propylacetate, butylacetate, 2-hydroxy ethylpropionate, 2-hydroxy 2-methyl methylpropionate, 2- hydroxy 2-methyl ethylpropionate, hydroxy methylacetate, hydroxy ethylacetate, hydroxy butylacetate, methyllactate, ethyllactate, propyllactate, butyllactate, 3-hydroxy methylpropionate, 3-hydroxy ethylpropionate, 3-hydroxy propylpropionate, 3-hydroxy butylpropionate, 2-hydroxy 3-methyl methylbutanoate, methoxymethylacetate, methoxyethylacetate, rhethoxypropylacetate, methoxybutylacetate, ethoxymethylacetate, ethoxyethylacetate, ethoxypropylacetate, ethoxybutylacetate, propoxymethylacetate, propoxyethylacetate, propoxypropylacetate, propoxybutylacetate, buthoxymethylacetate, buthoxyethylacetate, buthoxypropylacetate, buthoxybutylacetate, 2-methoxymethylpropionate, 2-methoxyethylpropionate, 2-methoxypropylpropionate, 2-methoxybutylpropionate, 2-ethoxymethylpropionate, 2-ethoxyethylpropionate, 2-ethoxypropylpropionate, 2-ethoxybutylpropionate, 2-buthoxymethylpropionate, 2-buthoxyethylpropionate, 2-buthoxypropylpropionate, 2-buthoxybutylpropionate, 3-methoxymethylpropionate, 3-methoxyethylpropionate, 3-methoxypropylpropionate, 3-methoxybutylpropionate, 3-ethoxymethylpropionate, 3-ethoxyethylpropionate, 3-ethoxypropylpropionate, 3-ethoxybutylpropionate, 3-propoxymethylpropionate, 3-propoxyethylpropionate, 3-propoxypropylpropionate, 3-propoxybutylpropionate, 3-buthoxymethylpropionate, 3-buthoxyethylpropionate, 3-buthoxypropylpropionate, and 3-buthoxybutylpropionate. These can be used alone or as a mixture.

A radical initiator is used in the polymerization of the above-mentioned alkali-soluble resin. The examples are: 2,2′-azobisisobutyronitrile, 2,2′-azobis(2,4-dimethylvaleronitrile), 2,2′-azobis(4-methoxy 2,4-dimethylvaleronitrile), 1,1′-azobis(cyclohexan-1-carbonitrile), and dimethyl 2,2′-azobisisobutylate.

The Mw of the alkali-soluble resin (A) in the invention should be 5000˜20,000. If the above-mentioned Mw is less than 5000, there is a tendency for the formed layer to be inferior in its developability, residue ratio, pattern topology, and heat resistance. If the Mw is larger than 20,000, the photosensitivity decreases and the topology of the formed pattern becomes poor.

The alkali-soluble resin (A) in the invention is polymerized in a solvent with good solubility for a copolymer. A poor solvent with low solubility for a copolymer of (A) is dripped into or mixed with the resulting copolymer solution, so that the copolymer solution precipitates. A copolymer solution of which the ratio of the unreacted monomer and the initiator is below 5% is obtained when the solution including the precipitated copolymer is extracted. It is best that the above-mentioned poor solvent is at least one selected from the group consisting of water, hexane, heptane, toluene, and a mixture thereof.

If the ratio of the unreacted monomer and the initiator is more than 5%, it is likely that transmissivity, residue ratio, heat resistance, and chemical resistance may deteriorate.

(B) Quinonediazide Sulfonic Ester Compound

It is desirable that the photosensitive compound of the photosensitive resin composition of the invention be the above-mentioned quinonediazide sulfonic ester compound.

The 1,2-quinonediazide compound used in the present invention can be a compound such as 1,2-quinonediazide 4-sulfonic ester, 1,2-quinonediazide 5-sulfonic ester, and 1,2-quinonediazide 6-sulfonic ester, etc.

The quinonediazide sulfonic ester compound is obtained by reacting a naphthoquinonediazidesulfonic halogen compound and a phenol compound as shown in chemical formula 1 in a weak base solution.

The examples of the compound shown in chemical formula 1 are:

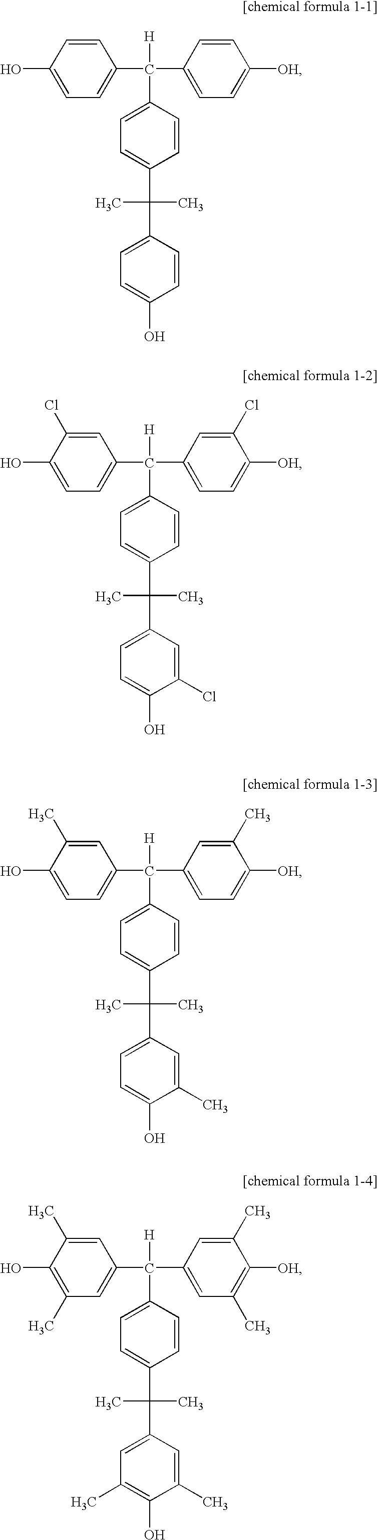

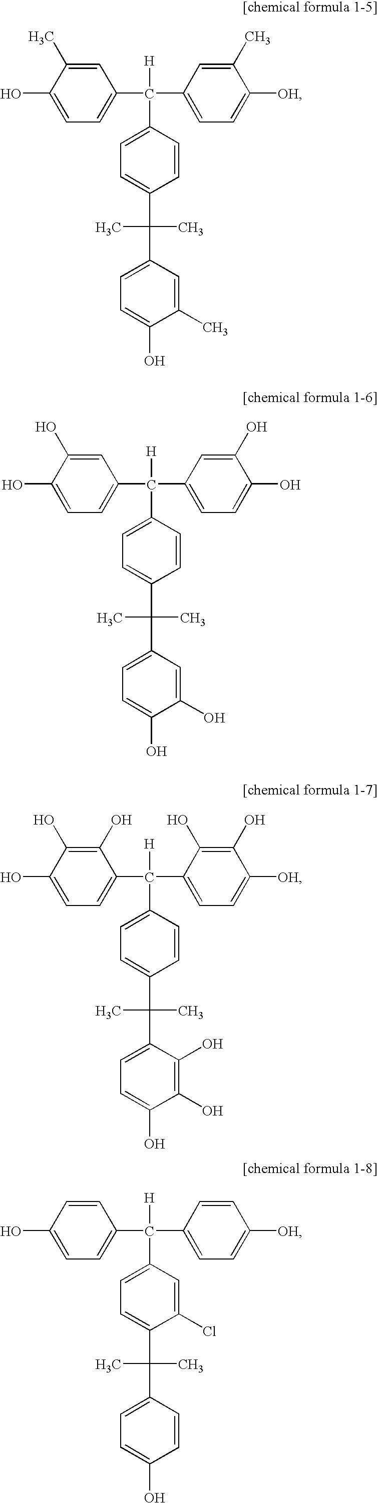

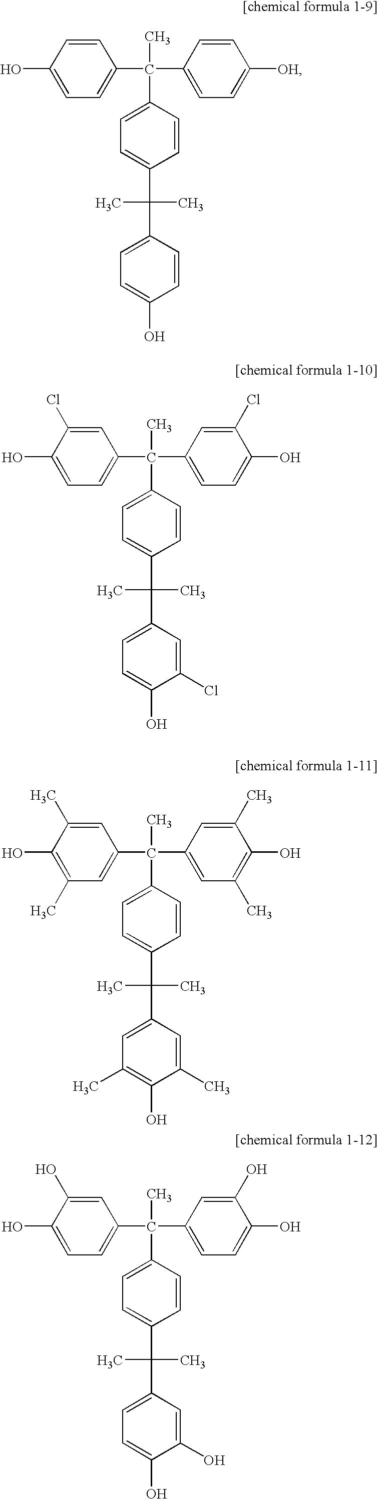

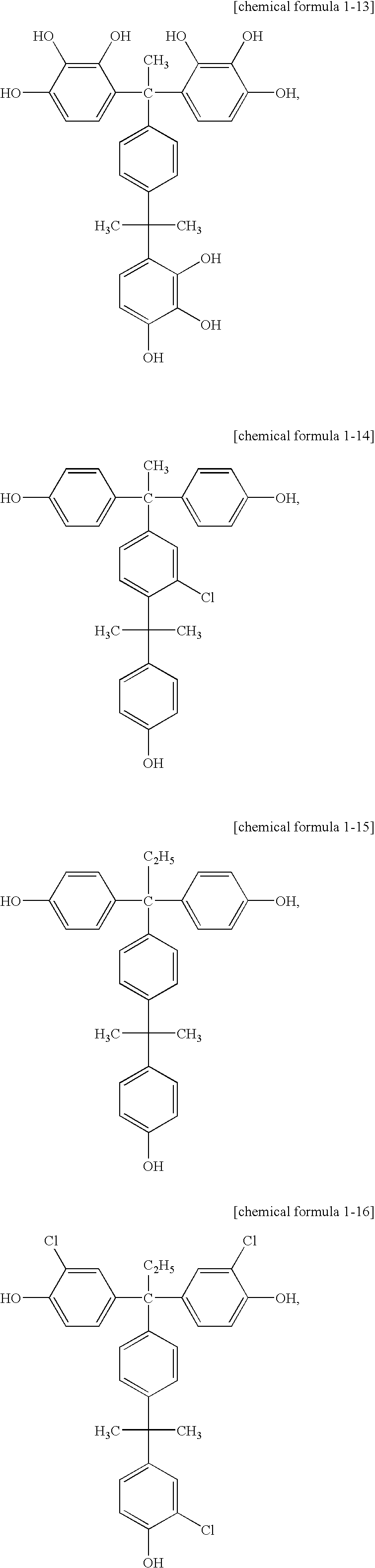

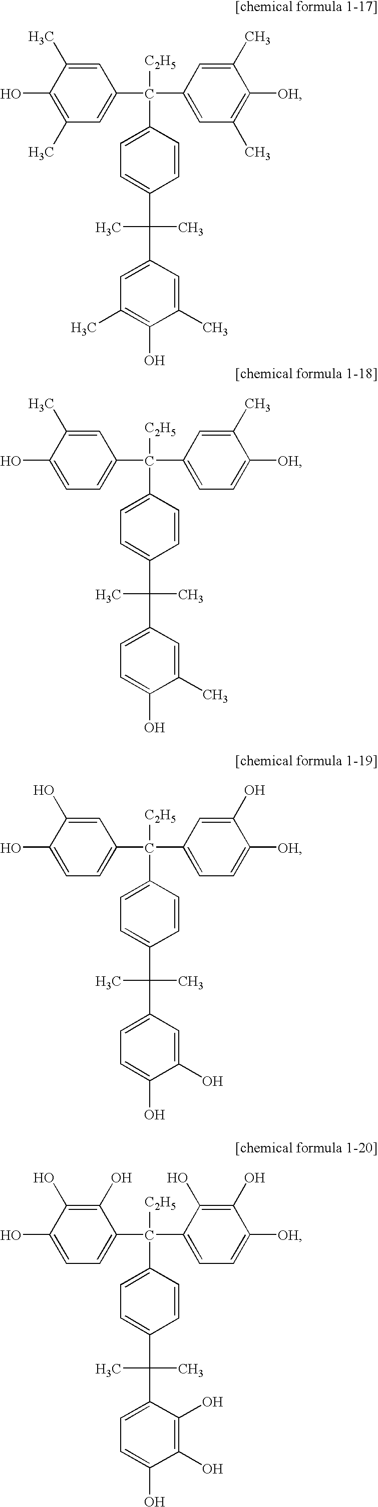

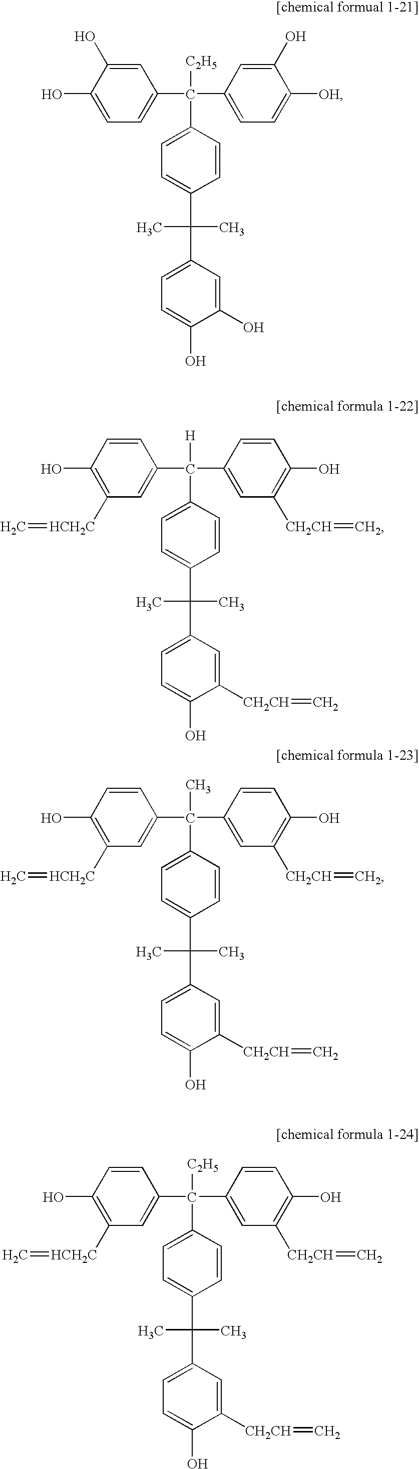

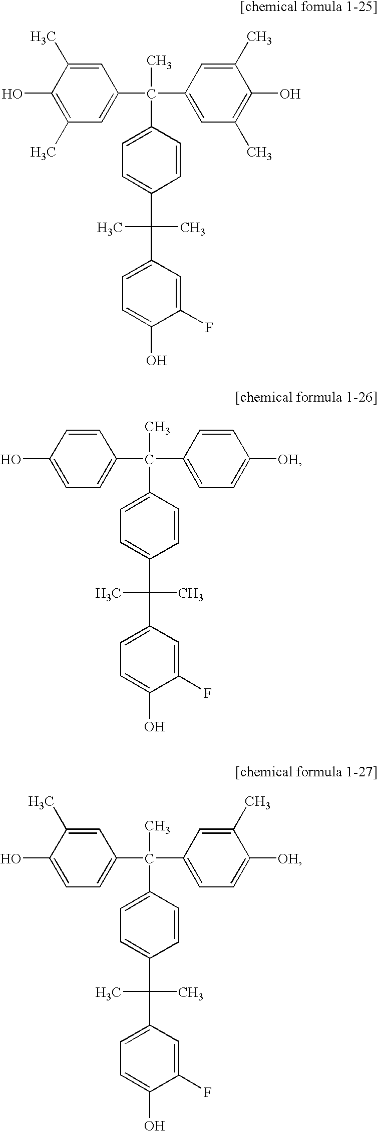

In synthesizing the above-mentioned compound, it is best that the esterization ratio be 50˜85%. If it is below 50%, the residue ratio is adversely affected, and if it exceeds 85%, stability may decrease.

Examples of the phenol compound used for the quinonediazide sufonic ester compound are: 2,3,4-trihydroxybenzophenon, 2,4,6-trihydroxybenzophenon, 2,2′ or 4,4′-tetrahydroxybenzophenon, 2,3,4,3′-tetrahydroxybenzophenon, 2,3,4,4′-tetrahydroxybenzophenon, 2,3,4,2′-tetrahydroxy 4′-methylbenzophenon, 2,3,4,4′-tetrahydroxy 3′-methoxybenzophenon, 2,3,4,2′ or 2,3,4,6′-pentahydroxybenzophenon, 2,4,6,3′, 2,4,6,4′ or 2,4,6,5′-hexahydroxybenzophenon, 3,4,5,3′, 3,4,5,4′ or 3,4,5,5′-hexahydroxybenzophenon, bis(2,4-dihydroxyphenyl) methane, bis(p-hydroxyphenyl) methane, tri(p-hydroxyphenyl) methane, 1,1,1-tri(p-hydroxyphenyl) ethane, bis(2,3,4- trihydroxyphenyl) methane, 2,2-bis(2,3,4-trihydroxyphenyl) propane, 1,1,3-tris (2,5-dimethyl 4-hydroxyphenyl)-3-phenylpropane, 4,4′-[1-[4-[1-[4-hydroxypheny]-1-methylethyl]phenyl]ethylidene]bisphenol, and bis(2,5-dimethyl 4-hydroxyphenyl)-2-hydroxyphenylmethane. The quinonediazide sulfonic ester compound obtained from the reaction of these materials is used alone or as a mixture.

The amount of the quinonediazide sulfonic ester compound should be 5˜100 weight %, and more desirably, 10˜50 weight % for 100 weight % of the alkali-soluble resin (A). If the amount of the quinonediazide sulfonic ester compound is below 5 weight %, the difference in solubility of the UV-exposed and the unexposed area becomes too small to form patterns. If the amount exceeds 100 weight %, too much quinonediazide sulfonic ester compound remains unreacted during short exposure, so that it becomes difficult to develop since the solubility in an alkaline water solution becomes too low.

In addition, the photosensitive resin composition in the invention may include, as necessary, (C) a nitric cross-linking agent with alkanols, (D) a polymer compound with an ethylene-type unsaturated double bond, (E) an epoxy resin, (F) an adhesion promotor, and (G) a surfactant.

At least one of the compounds of the nitric cross-linking agent with alkanols (C) has alkanols with 1˜4 carbon atoms, and it forms a cross-link with molecules of the alkali-soluble resin (A). Examples of the nitric cross-linking agent are: condensates of urea and formaldehyde, condensates of melamine and formaldehyde, methylolureaalkylethers derived from alcohols, and methylolmelaminealkylethers. More preferably, the following compounds as the above-mentioned nitric cross-linking agent can use chemical formula 2, chemical formula 3, chemical formula 4, chemical formula 5, chemical formula 6, chemical formula 7, or chemical formula 8.

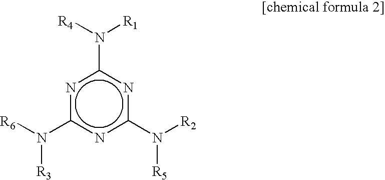

wherein R₁, R₂, and R₃ are —CH₂O (CH₂)ₙCH₃; n is an integer of 0˜3; and R₄, R₅, and R₆ are either hydrogen, —(CH₂)mOH (where m is an integer of 1˜4), or —CH₂O(CH₂)ₙCH₃ (where n is an integer of 0˜3), and at least one of them is an alkanol.

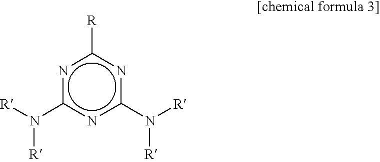

wherein R is a phenyl or an alkyl with 1˜4 carbon atoms; and R′ is hydrogen, —(CH₂)ₘOH (m=1˜4), or —CH₂O (CH₂)ₙCH₃ (n=0˜3), at least one of them being an alkanol.

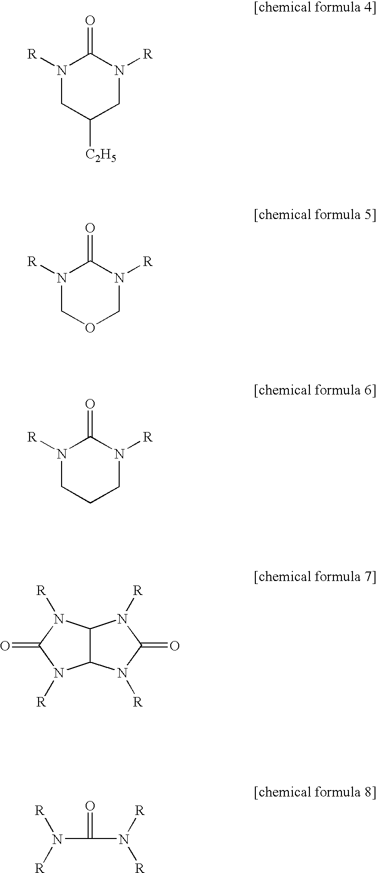

wherein R is hydrogen, —(CH₂)ₘOH (m=1˜4), or —CH₂O(CH₂)ₙCH₃ (n=0˜3), and at least one of them is an alkanol.

Examples of the urea-formaldehyde condensates are monomethylolurea and dimethylolurea. Examples of the melamine-formaldehyde condensates are hexamethylolmelamine and partial condensates of melamine and formaldehyde. The above-mentioned methylolureaalkylethers are obtained from reaction of urea-formaldehyde condensates and alcohols. Examples thereof are monomethylureamethylether and dimethylureamethylether.

The above-mentioned methylolmelaminealkylethers are obtained from reaction of melamine-formaldehyde condensates and alcohols. Examples are hexamethylolmelaminehexamethylether, hexamethylolmelaminehexabutylether, a compound derived by displacing the hydrogen of the amino group of melamine with a hydroxy methyl or a methoxy methyl, and a compound derived by displacing the hydrogen of the amino group of melamine with a buthoxy methyl or a methoxy methyl. It is best to use methylol melamine alkyl ethers among these.

The amount of the (C) nitric cross-linking agent should be 2˜35 weight %, and more desirably, 5˜25 weight % for 100 weight % of the alkali-soluble resin (A). If the amount of (C) is less than 2 weight %, cross linkage is insufficient, and if it exceeds 35 weight %, the thickness of the unexposed area is severely reduced and the transmissivity decreases.

The above-mentioned polymer compound with an ethylene unsaturated double bond (D) improves the heat resistance and photosensitivity of the pattern formed from the photosensitive resin composition. Examples of the polymer compound with an ethylene unsaturated double bond are monofunctional methacrylate, difunctional methacrylate, or tri- or more functional methacrylate. Monofunctional methacrylates such as 2-hydroxyethyl methacrylate, isobornylmethacrylate, 3-methoxybutylmethacrylate, and 2-methaacryloxyethyl 2-hydroxypropylphthalate; difunctional methacrylates such as ethyleneglycol methacrylate, 1,6-hexanedioldimethacrylate, 1,9-nonandioldimethacrylate, propyleneglycol methacrylate, tetraethyleneglycolmethacrylate, bisphenoxyethanolfluorendiacrylate, and tri- or more functional methacrylate such as trimethylolpropanetrimethacrylate, pentaerythritoltrimethacrylate, pentaerythritoltetramethacrylate, dipentaerythritolpentamethacrylate, and dipentaerythritolhexamethacrylate are preferably used. These can be used alone or as a mixture. The amount of the compound (D) should be 1˜50 weight %, and more desirably, 5˜30 weight % for 100 weight % of the alkali-soluble resin (A).

The epoxy resin (E) improves the heat resistance and photosensitivity of the pattern formed from the photosensitive resin composition. Examples of the epoxy resin are: bisphenol A-type epoxy resin, phenol novolac-type epoxy resin, crezol novolac-type epoxy resin, alicyclic epoxy resin, glycidyl ester-type epoxy resin, glycidyl amine-type epoxy resin, heterocyclic epoxy resin, and resins from (co)polymerization of glycidyl methacrylate other than the alkali-soluble resin (A). It is best to use bisphenol A-type epoxy resin, crezol novolac-type epoxy resin, or glycidyl ester-type epoxy resin. The amount of the epoxy resin should be 0.1˜30 weight % for 100 weight % of the alkali-soluble resin. If the amount exceeds 30 weight %, the compatibility with the alkali-soluble resin decreases so that coating becomes difficult.

The adhesion promotor (F) is used to improve the adhesion to substrates. The amount should be 0.1˜20 weight % for 100 weight % of the alkali-soluble resin. Examples of the adhesion promotor are silane coupling agents with reactive substituents of carboxyl, methacryl, isocyanate, and epoxy. The examples are γ-methacryloxypropyltrimethoxysilane, vinyltriacetoxysilane, vinyltrimethoxysilane, γ-isocyanatepropyltriethoxysilane, γ-glycidoxypropyltrimethoxysilane, and β-(3,4-epoxy cyclo hexyl etliyltrimethoxysilane.

In addition, the surfactant (G) is used to improve the coatability and developability of the photosensitive composition. The examples are: polyoxyethyleneoctylphenylether; polyoxyethylenenonylphenylether; F171, F172, F173 (commercial products: Dai Nippon Ink);. FC430, FC431 (commercial products: Sumitomo-3M); and KP341 (commercial product: Sinweol Chemical). The amount of the surfactant should be 0.0001˜2 weight % for solid 100 weight %.

The present invention provides a photosensitive resin composition coating solution by adding a solvent to a photosensitive resin composition including the alkali-soluble resin (A), 1,2-quinonediazide compound (B), and chemicals (C)˜(G) as necessary.

The solid concentration of the photosensitive resin composition coating solution should be 30˜70 weight %. It is used after being filtered with a Millipore filter of roughly 0.2 μm.

Examples of the solvent used in the manufacturing of the photosensitive resin composition coating solution are: alcohols such as methanol and ethanol; ethers such as tetrahydrofurane; glycolethers such as ethyleneglycolmonomethylether and ethyleneglycolmonoethylether; ethyleneglycolalkylether acetates such as methylcellosolveacetate and ethylcellosolveacetate; diethyleneglycols such as diethyleneglycolmonomethylether, diethyleneglycolmonoethylether, and diethyleneglycoldimethylether; propyleneglycolmonoalkylethers such as propyleneglycolmethylether, propyleneglycolethylether, propyleneglycolpropylether, and propyleneglycolbutylether; propyleneglycolalkyletheracetates such as propyleneglycolmethyletheracetate, propyleneglycolethyletheracetate, propyleneglycolpropyletheracetate, and propyleneglycolbutyletheracetate; propyleneglycolalkyletheracetates such as propyleneglycolmethyletherpropionate, propyleneglycolethyletherpropionate, propyleneglycolpropyletherpropionate, and propyleneglycolbutyletherpropionate; aromatic carbohydrates such as toluene and xylene; ketones such as methylethylketone, cyclohexanon, and 4-hydroxy 4-methyl 2-pentanon; and esters such as methylacetate, ethylacetate, propylacetate, butylacetate, 2-hydroxy ethylpropionate, 2-hydroxy 2-methylmethylpropionate, 2-hydroxy 2-methylethylpropionate, hydroxymethylacetate, hydroxyethylacetate, hydroxybutylacetate, methyllactate, ethyllactate, propyllactate, butyllactate, 3-hydroxymethylpropionate, 3-hydroxyethylpropionate, 3-hydroxypropylpropionate, 3-hydroxybutylpropionate, 2-hydroxy 3-methylmethylbutyrate, methoxymethylacetate, methoxyethylacetate, methoxypropylacetate, methoxybutylacetate, ethoxymethylacetate, ethoxyethylacetate, ethoxypropylacetate, ethoxybutylacetate, propoxymethylacetate, propoxyethylacetate, propoxypropylacetate, propoxybutylacetate, buthoxymethylacetate, buthoxyethylacetate, buthoxypropylacetate, buthoxybutylacetate, 2-methoxymethylpropionate, 2-methoxyethylpropionate, 2-methoxypropylpropionate, 2-methoxybutylpropionate, 2-ethoxymethylpropionate, 2-ethoxyethylpropionate, 2-ethoxypropylpropionate, 2-ethoxybutylpropionate, 2-buthoxymethylpropionate, 2-buthoxyethylpropionate, 2-buthoxypropylpropionate, 2-buthoxybutylpropionate, 3-methoxymethylpropionate, 3-methoxyethylpropionate, 3-methoxypropylpropionate, 3-methoxybutylpropionate, 3-ethoxymethylpropionate, 3-ethoxyethylpropionate, 3-ethoxypropylpropionate, 3-ethoxybutylpropionate, 3-propoxymethylpropionate, 3-propoxyethylpropionate, 3-propoxypropylpropionate, 3-propoxybutylpropionate, 3-buthoxymethylpropionate, 3-buthoxyethylpropionate, 3-buthoxypropylpropionate, and 3-buthoxybutylpropionate. It is best to choose from glycolethers, ethyleneglycolalkyletheracetates, and diethyleneglycols, which have excellent solubility, reactivity, and coatability.

In the present invention, an insulating layer is applied after coating the photosensitive resin composition on a substrate by spraying, rollcoating, or spin-coating, and then evaporating the solvent by prebaking. The prebaking is executed at 70˜110° C. for 1˜15 minutes. After that, the coated layer is exposed to visible light, UV light, deep UV light, or X-rays, and it is developed with a developer to remove the unwanted area to form the desired pattern.

The above-mentioned developer is an alkaline water solution. Examples are water solutions of: inorganic alkalis such as sodium hydroxide, potassium hydroxide, and sodium carbonate; 1^{st} class amines such as ethylamine, and n-propylamine; 2^{nd} class amines such as diethylamine,; 3^{rd} class amines such as trimethylamine, methyldiethylamine, dimethylethylamine, and triethylamine; alcohol amines such as dimethylethanolamine, methyldiethanolamine, and triethanol amine; and 4^{th} class ammonium salts such as tetramethylammoniumhydroxide and tetraethylammoniumhydroxide. The developer is made from a solution of the alkali compound at a 0.1˜10% concentration. A proper amount of surfactant and water-soluble organic solvent such as methanol and ethanol can also be added.

Patterns are formed, after developing, by rinsing with pure water for 30˜90 seconds to remove the unwanted area, and baking. The final pattern is obtained by illuminating the above pattern with light such as UV, and baking it in an oven at 150˜250° C. for 30˜90 minutes.

As a result, the present invention provides LCDs and semiconductors with patterns of excellent transmissivity.

The subsequent section explains the present invention with Application Examples and Comparison Examples. However, these examples have the sole purpose of illustrating the invention, and the invention is not confined to these examples.

### APPLICATION EXAMPLE

### Synthesis Example 1

20 g of the compound of chemical formulas 1-9, 26.57 g of 1,2-naphthoquinonediazide 5-sulfonyl chloride, and 186.29 g of dioxane were put into a 3-neck flask, stirred at room temperature, and dissolved. After sufficient dissolution, 60.07 g of a triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B1).

### Synthesis Example 2

20 g of the compound of chemical formulas 1-9, 30.37 g of 1,2-naphthoquinonediazide 5-sulfonyl chloride, and 201.48 g of dioxane were put into a 3-neck flask, stirred at room temperature, and dissolved. After sufficient dissolution, 68.65 g of a triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B2).

### Synthesis Example 3

20 g of the compound of chemical formulas 1-11, 22.18 g of 1,2-naphthoquinonediazide 5-sulfonyl chloride, and 168.71 g of dioxane were put into a 3-neck flask, stirred at room temperature, and dissolved. After sufficient dissolution, 50.13 g of a triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B3).

### Synthesis Example 4

20 g of the compound of chemical formulas 1-11, 25.35 g of 1,2-naphthoquinonediazide 5-sulfonyl chloride, and 181.38 g of dioxane were put into a 3-neck flask, stirred at room temperature, and dissolved. After sufficient dissolution, 57.29 g of a triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B4).

### Synthesis Example 5

20 g of the compound of chemical formulas 1-25, 22.62 g of 1,2-naphthoquinonediazide 5-sulfonyl chloride, and 170.50 g of dioxane were put into a 3-neck flask, stirred at room temperature, and dissolved. After sufficient dissolution, 51.14 g of triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B5).

### Synthesis Example 6

20 g of the compound of chemical formulas 1-25, 25.86 g of 1,2-naphthoquinonediazide 5-sulfonyl chloride, and 183.43 g of dioxane were put into a 3-neck flask, stirred at room temperature, and dissolved. After sufficient dissolution, 58.45 g of triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B6).

### Synthesis Example 7

20 g of the compound of chemical formulas 1-26, 25.49 g of 1,2-naphthoquinonediazide 5-sulfonyl chloride, and 181.97 g of dioxane were put into a 3-neck flask, stirred at room temperature, and dissolved. After sufficient dissolution, 61.93 g of triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B7).

### Synthesis Example 8

20 g of the compound of chemical formulas 1-26, 29.13 g of 1,2-naphthoquinonediazide 5-sulfonyl chloride, and 196.54 g of dioxane were put into a 3-neck flask, stirred at room temperature, and dissolved. After sufficient dissolution, 65.86 g of triethylamine 20% dioxane solution were dripped slowly therein for 30 minutes. The mixture was left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B8).

### Synthesis Example 9

20 g of the compound of chemical formulas 1-27, 23.97 g of 1,2-naphthoquinonediazide 5-sulfonyl chloride, and 175.89 g of dioxane were put into a 3-neck flask, stirred at room temperature, and dissolved. After sufficient dissolution, 54.19 g of triethylamine 20% dioxane solution were dripped slowly therein for 30 minutes. The mixture left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B9).

### Synthesis Example 10

20 g of the compound of chemical formulas 1-27, 27.40 g of 1,2-naphthoquinonediazide 5-sulfonyl chloride, and 189.59 g of dioxane were put into a 3-neck flask, stirred at room temperature, and dissolved. After sufficient dissolution, 61.93 g of triethylamine 20% dioxane solution were dripped slowly therein for 30 minutes. The mixture left to react for 3 hours, then the precipitated triethylaminehydrochloride was filtered out. The filtered solution was dripped into a weak acidic water solution, to precipitate a product. The extracted precipitate was rinsed with pure water, filtered, and baked in an oven at 40° C., to yield a quinonediazide compound (B10).

### Synthesis Example 11

7 weight % of 2,2′-azobis(2,4-dimethylvaleronitrile), 200 weight % of tetrahydrofurane, 13 weight % of methacrylic acid, 24 weight % of glycidylmethacrylate, 28 weight % of styrene, 5 weight % of 2-hydroxyethylacrylate, and 30 weight % of isobornylacrylate were put into a flask equipped with a cooling pipe and a stirrer. These were nitrogen-displaced and stirred gently. The solution was heated to 62° C. and held at this temperature for 8 hours, to obtain a polymer solution including a copolymer [a-1]. 900 weight % of hexane was dripped into the polymer solution [a-1], to precipitate a copolymer. The precipitated copolymer solution was separated. 150 weight % of propyleneglycolmonomethyletheracetate was added. It was then heated to 40° C. and distilled under reduced pressure, to yield a copolymer [A-1]. The concentration of the solid of the copolymer solution was 30%, and GPC analysis showed that the Mw was 9400 and the ratio of the unreacted monomer and the initiator was 1.6%.

### Synthesis Example 12

7 weight % of 2,2′-azobis(2,4-dimethylvaleronitrile), 200 weight % of tetrahydrofurane, 15 weight % of methacrylic acid, 15 weight % of glycidylmethacrylate, 30 weight % of styrene, 7 weight % of 2-hydroxyethylacrylate, and 33 weight % of isobornylacrylate were put into a flask equipped with a cooling pipe and a stirrer. These were nitrogen-displaced and stirred gently. The solution was heated to 62° C. and held at this temperature for 8 hours, to obtain a polymer solution including a copolymer [a-2]. 900 weight % of hexane was dripped into the polymer solution [a-2], to precipitate a copolymer. The precipitated copolymer solution was separated. 150 weight % of propyleneglycolmonomethyletheracetate was added. It was then heated to 40° C. and distilled under reduced pressure, to yield a copolymer [A-2]. The concentration of the solid of the copolymer solution was 30%, and GPC analysis showed that Mw was 9300 and the ratio of the unreacted monomer and the initiator was 0.7%.

### Example 1

Manufacture of Positive Photosensitive Hardened Layer Composition

100 weight % (equal to the solid) of a polymer solution (copolymer [A-1]) obtained from Synthesis Example 11, and 25 weight % of compound B1 obtained from Synthesis Example 1 were mixed and dissolved in diethyleneglycoldimethylether, so that the concentration of the solid was 35 weight %. It was then filtered with a Millipore filter of 0.2 μm to produce a solution of a positive photosensitive hardened layer composition.

The physical properties of the synthesized photosensitive resin composition were measured by the following methods, and the results are shown in Table 1.

1) Sensitivity: The composition solution was coated on a glass substrate using a spin-coater. A layer was formed after prebaking on a hot plate at 90° C. for 2 minutes.

The layer was illuminated through a patterned mask by UV light of 15 mW/cm² at 365 nm for 20 seconds, developed with a water solution of 2.38 weight % tetramethylammoniumhydroxide at 25° C. for 1 minute, and rinsed with pure water for 1 minute.

The developed pattern was exposed to UV light of 15 mW/cum² at 365 nm for 34 seconds and hardened after being heated in an oven at 220° C. for 60 minutes.

2) Resolution: the minimum dimension of the formed pattern obtained above.

3) Residue ratio: the change in the layer thickness before and after development.

4) Transmissivity: transmissivity of the patterned layer at 400 nm, measured using a spectroscope.

### Example 2

A composition solution was produced and evaluated using the same method as in Example 1, except that a polymer solution including the 1,2-quinonediazide compound (B2) produced in Synthesis Example 2 was used instead of the polymer solution including the 1,2-quinonediazide compound (B1) produced in Synthesis Example 1. The results are shown in Table 1.

### Example 3

A composition solution was produced and evaluated using the same method as in Example 1, except that a polymer solution including the 1,2-quinonediazide compound (B3) produced in Synthesis Example 3 was used instead of the polymer solution including the 1,2-quinonediazide compound (B1) produced in Synthesis Example 1. The results are shown in Table 1.

### Example 4

A composition solution was produced and evaluated using the same method as in Example 1, except that a polymer solution including the 1,2-quinonediazide compound (B4) produced in Synthesis Example 4 was used instead of the polymer solution including the 1,2-quinonediazide compound (B1) produced in Synthesis Example 1. The results are shown in Table 1.

### Example 5

A composition solution was produced and evaluated using the same method as in Example 1, except that a polymer solution including the 1,2-quinonediazide compound (B5) produced in Synthesis Example 5 was used instead of the polymer solution including the 1,2-quinonediazide compound (B1) produced in Synthesis Example 1. The results are shown in Table 1.

### Example 6

A composition solution was produced and evaluated using the same method as in Example 1, except that a polymer solution including the 1,2-quinonediazide compound (B6) produced in Synthesis Example 6 was used instead of the polymer solution including the 1,2-quinonediazide compound (B1) produced in Synthesis Example 1. The results are shown in Table 1.

### Example 7

A composition solution was produced and evaluated using the same method as in Example 1, except that a polymer solution including the 1,2-quinonediazide compound (B7) produced in Synthesis Example 7 was used instead of the polymer solution including the 1,2-quinonediazide compound (B1) produced in Synthesis Example 1, that the copolymer solution [A-2] produced in Synthesis Example 12 was used instead of the copolymer solution [A-1] produced in Synthesis Example 11, and that a water solution of 0.8 weight % tetramethylammoniumhydroxide was used as a developer. The results are shown in Table 1.

### Example 8

A composition solution was produced and evaluated using the same method as in Example 1, except that the polymer solution including 1,2-quinonediazide compound (B8) produced in Synthesis Example 8 was used instead of the polymer solution including 1,2-quinonediazide compound (B1) produced in Synthesis Example 1, that the copolymer solution [A-2] produced in Synthesis Example 12 was used instead of the copolymer solution [A-1] produced in Synthesis Example 11, and that a water solution of 0.8 weight % tetramethylammoniumhydroxide was used as a developer. The results are shown in Table 1.

### Example 9

A composition solution was produced and evaluated using the same method as in Example 1, except that the polymer solution including 1,2-quinonediazide compound (B9) produced in Synthesis Example 9 was used instead of the polymer solution including 1,2-quinonediazide compound (B1) produced in Synthesis Example 1, that the copolymer solution [A-2] produced in Synthesis Example 12 was used instead of the copolymer solution [A-1] produced in Synthesis Example 11, and that a water solution of 0.8 weight % tetramethylammoniumhydroxide was used as a developer. The results are shown in Table 1.

### Example 10

A composition solution was produced and evaluated using the same method as in Example 1, except that the polymer solution including 1,2-quinonediazide compound (B10) produced in Synthesis Example 10 was used instead of the polymer solution including 1,2-quinonediazide compound (B1) produced in Synthesis Example 1, that the copolymer solution [A-2] produced in Synthesis Example 12 was used instead of the copolymer solution [A-1] produced in Synthesis Example 11, and that a water solution of 0.8 weight % tetramethylammoniumhydroxide was used as a developer. The results are shown in Table 1.

### Comparative Example 1

A composition solution was produced and evaluated using the same method as in Example 1, except that a polymer solution including 15 weight % of 2,3,4,4-tetrahydroxybenzophenone 1,2-naphthoquinonediazide 5-sulfonic ester, a condensate obtained from a reaction of 1 mol of 2,3,4,4-tetrahydroxybenzophenone, and 3 mol of 1,2-naphthoquinonediazide 5-sulfonyl chloride; and 15 weight % of tri(p-hydroxyphenyl) methane 1,2-naphthoquinonediazide 5-sulfonic ester, a condensate obtained from a reaction of 1 mol of tri(p-hydroxyphenyl)methane, and 2 mol of 1,2-naphthoquinonediazide 5-sulfonyl chloride were used instead of the polymer solution including the 1,2-quinonediazide compound (B1) produced in Synthesis Example 1. The results are shown in Table 1.

### Comparative Example 2

A composition solution was produced and evaluated using the same method as in Example 1, except that a polymer solution including 15 weight % of 2,3,4,4-tetrahydroxybenzophenone 1,2-naphthoquinonediazide 5-sulfonic ester, a condensate obtained from a reaction of 1 mol of 2,3,4,4-tetrahydroxybenzophenone, and 3 mol of 1,2-naphthoquinonediazide 5-sulfonyl chloride; and 15 weight % of tri(p-hydroxyphenyl) methane 1,2-naphthoquinonediazide 5-sulfonic ester, a condensate obtained from a reaction of 1 mol of tri(p-hydroxyphenyl)methane and 2 mol of 1,2-naphthoquinonediazide 5-sulfonyl chloride were used instead of the polymer solution including the 1,2-quinonediazide compound (B1) produced in Synthesis Example 1, and that the copolymer solution [A-2] produced in Synthesis Example 12 was used instead of the copolymer solution [A-1] produced in Synthesis Example 11. The results are shown in Table 1.

TABLE 1

| | Sensitivity | Resolution | Residue ratio | % |
|---|---|---|---|---|
| | (mJ/cm²) | (μm) | (%) | Transmission |
| Example 1 | 200 | 3 | 89 | 92 |
| Example 2 | 250 | 3 | 91 | 92 |
| Example 3 | 260 | 2 | 90 | 92 |
| Example 4 | 310 | 2 | 90 | 92 |
| Example 5 | 245 | 3 | 90 | 92 |
| Example 6 | 290 | 3 | 90 | 91 |
| Example 7 | 220 | 3 | 90 | 90 |
| Example 8 | 275 | 3 | 92 | 92 |
| Example 9 | 240 | 3 | 92 | 92 |
| Example 10 | 290 | 3 | 92 | 91 |
| Comp. | 230 | 4 | 80 | 79 |
| Example 1 | | | | |
| Comp. | 260 | 4 | 84 | 81 |
| Example 2 | | | | |

Table 1 shows that, having the quinonediazide sulfonic ester compound derived from the phenol compounds of chemical formula 1, the positive photosensitive insulating layer compositions of Example 1˜10 according to the present invention have excellent transmissivity, residue ratio, and heat resistance as well as good sensitivity and resolution. They are suitable for forming a thick insulating layer, which is necessary for a high degree of planarization. On the other hand, transmissivity and heat resistance of the resins in Comparative Example 1 and 2 are poor. In particular, the residue ratio is low so it is difficult to use it for a thick insulating layer.

As shown in the above, the positive photosensitive insulating layer resin composition according to the present invention has excellent properties of photosensitivity, residue ratio, heat/chemical resistance, and smoothness. In particular, it can be easily patterned as insulating layers and even its thick layers have good transmission. Therefore, it is suitable as a material for the insulating layers of LCDs and semiconductors.

1. A photosensitive resin composition comprising
(A) an alkali-soluble acrylic copolymer resin, which is the product of copolymerization of
i) unsaturated carboxylic acid, anhydrous unsaturated carboxylic acid, or their mixture,
ii) an unsaturated compound with epoxy group(s), and
iii) an unsaturated compound of olefin,
and which has a polystyrene-equivalent molecular weight (Mw) of 5000˜20,000; and
(B) a photosensitive quinonediazide sulfonic ester compound, a product of the following compound shown in chemical formula 1, as its photosensitive composition: 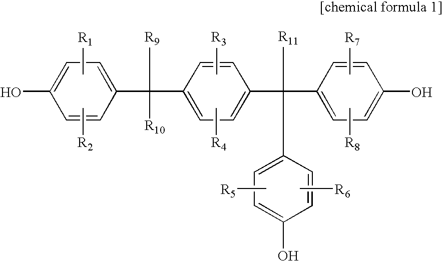
wherein R₁ to R₆ are independently or simultaneously hydrogen, a halogen, an alkyl with 1˜4 carbon atoms, an alkenyl with 1˜4 carbon atoms, or a hydroxyl; R₇ and R₈ are independently or simultaneously hydrogen, a halogen, or an alkyl with 1˜4 carbon atoms; and R₉ to R₁₁ are independently or simultaneously hydrogen or alkyls with 1˜4 carbon atoms.

2. The photosensitive resin composition according to claim 1, wherein said composition comprises:
(A) 100 weight % of an alkali-soluble acrylic copolymer resin with a polystyrene equivalent molecular weight (Mw) of 5000˜20,000, obtained from the copolymerization of
i) 5˜40 weight % of unsaturated carboxylic acid, anhydrous unsaturated carboxylic acid, or their mixture;
ii) 10˜70 weight % of an unsaturated compound with epoxy group(s); and
iii) 10˜70 weight % of an unsaturated compound of olefin; and
(B) 5˜100 weight % of a photosensitive quinonediazide sulfonic ester compound obtained from the reaction of the compound shown in chemical formula 1.

3. The photosensitive resin composition according to claim 1, wherein said alkali-soluble resin (A) is produced by
dripping or mixing a poor solvent that has low solubility to alkali-soluble resin (A) into a copolymer solution of i) unsaturated carboxylic acid, anhydrous unsaturated carboxylic acid, or their mixture; ii) an unsaturated compound with epoxy group(s); and iii) an unsaturated compound of olefin,
precipitating the copolymer solution, and
separating the solution.

4. The photosensitive resin composition according to claim 3, wherein said poor solvent is one or a combination of water, hexane, heptane, and toluene.

5. The photosensitive resin composition according to claim 1, wherein said unsaturated carboxylic acid, anhydrous unsaturated carboxylic acid, or their mixture in (A)i) is one or a combination of acrylic acid, methacrylic acid, maleic acid, fumaric acid, citraconic acid, mesaconic acid, itaconic acid, and their anhydrides.

6. The photosensitive resin composition according to claim 1, wherein said unsaturated compound with epoxy group(s) in (A)ii) is one or a combination of glycidylacrylate, glycidylmethacrylate, α-ethylglycidylacrylate, α-n-propylglycidylacrylate, α-n-butylglycidylacrylate, acrylic acid-β-methylglycidyl, methacrylic acid-β-methylglycidyl, acrylic acid-β-ethylglycidyl, methacrylic acid-β-ethylglycidyl, acrylic acid-3,4-epoxybutyl, methacrylic acid-3,4-epoxybutyl, acrylic acid-6,7-epoxyheptyl, methacrylic acid-6,7-epoxyheptyl, α-ethyl acrylic acid-6,7-epoxyheptyl, o-vinylbenzyl glycidyl ether, m-vinylbenzyl glycidyl ether, and p-vinylbenzyl glycidyl ether.

7. The photosensitive resin composition according to claim 1, wherein said unsaturated compound of olefin in (A)iii) is one or a combination of methylmethacrylate, ethylmethacrylate, n-butyl methacrylate, sec-butylmethacrylate, t-butyl methacrylate, methylacrylate, isopropyl acrylate, cyclohexyl methacrylate, 2-methylcyclo hexylmethacrylate, dicyclopentanyloxyethylmethacrylate, isobornylmethacrylate, cyclohexylacrylate, 2-methylcyclohexylacrylate, dicyclopentanyloxyethylacrylate, isobornylacrylate, phenylmethacrylate, phenylacrylate, benzylacrylate, 2-hydroxyethylmethacrylate, styrene, α-methyl styrene, m-methyl styrene, p-methyl styrene, vinyltoluene, p-methyl styrene, 1,3-butadiene, isoprene, and 2,3-dimethyl 1,3-butadiene.

8. The photosensitive resin composition according to claim 1, wherein said photosensitive resin composition includes an additive which is one or a combination of (C) 2˜35 weight % of a nitric cross-linking agent with alkanols, (D) 1˜50 weight % of a polymer compound with ethylene-type unsaturated double bonds, (E) 0.1˜30 weight % of epoxy resin, (F) 0.1˜20 weight % of an adhesion promotor, and (G) 0.0001˜2 weight % of a surfactant.

9. The photosensitive resin composition according to claim 8, wherein said nitric cross-linking agent with alkanols is a compound represented by chemical formula 2, chemical formula 3, chemical formula 4, chemical formula 5, chemical formula 6, chemical formula 7, or chemical formula 8: 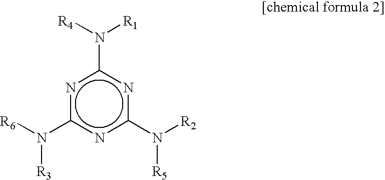
wherein R₁, R₂, and R₃ are —CH₂O(CH₂)ₙCH₃; N is an integer of 0˜3; and R₄, R₅, and R₆ are either hydrogen, —(CH₂)mOH (where m is an integer of 1˜4), or —CH₂O(CH₂)ₙCH₃ (where n is an integer of 0˜3), at least one of them being an alkanol, 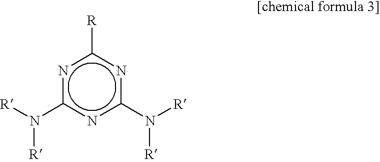
wherein R is a phenyl or an alkyl with 1˜4 carbon atoms; and R′ is hydrogen, —(CH₂)ₘOH (m=1˜4), or —CH₂O(CH₂)ₙCH₃ (n=0˜3), at least one of them being an alkanol, 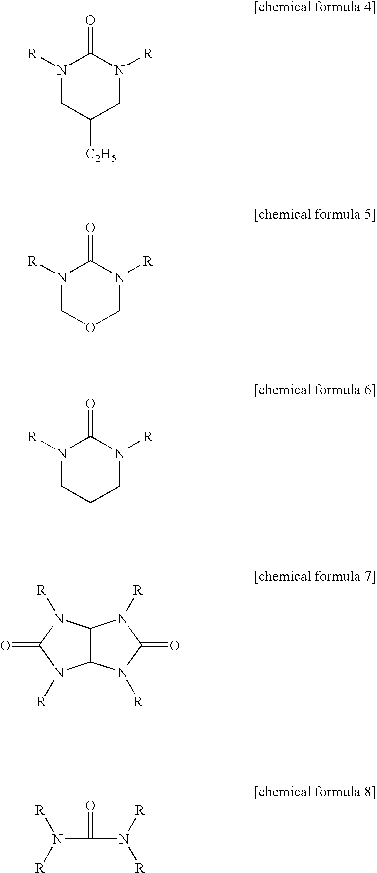
wherein R is hydrogen, —(CH₂)ₘOH (m=1˜4), or —CH₂O(CH₂)ₙCH₃ (n=0˜3), at least one of them being an alkanol.

10. A method for forming a photoresist pattern, comprising patterning an 10 insulating layer produced by coating of said photosensitive resin composition according to claim 1.

11. A semiconductor device including the photoresist pattern formed by said method according to claim 10.
